(19) United States
(12) Patent Application Publication
(10) Pub. No.: US 2017/0233995 A1
(43) Pub. Date: Aug. 17, 2017

(54) CONNECTORS AND METHODS OF ASSEMBLING THE SAME

(71) Applicant: Bull Moose Tube Company, Chesterfield, MO (US)

(72) Inventor: Mark Scott Abernathy, Ballwin, MO (US)

(21) Appl. No.: 15/044,910

(22) Filed: Feb. 16, 2016

(51) Int. Cl. E04B 1/18; F16B 7/18

(52) U.S. Cl. CPC E04B 1/185; F16B 7/182

(57) ABSTRACT

A connector is provided. The connector includes a flange defining an opening. The connector also includes an insert having a plurality of plates. Each of the plates extends through the opening of the flange. The connector further includes an actuator coupling the insert to the flange. The plurality of plates are movable relative to the flange by operating the actuator.

### BACKGROUND

The field of this disclosure relates generally to connectors and, more particularly, to a connector for use in coupling together tubular support members in a building frame.

Many known building structures have a frame that includes a plurality of beams and a plurality of columns. When erecting a taller (e.g., multistory) building, it is necessary to include columns that extend from the ground upwards for multiple stories. However, it can be difficult to transport full-length columns to the building site, and rather typically such columns are transported in segments that are ultimately welded together at the building site. However, depending on the completed height of the building structure, it may be difficult to assemble such columns at the building site. Moreover, assembling such columns at the building site by welding together the column segments can be time consuming and costly.

### BRIEF DESCRIPTION

In one aspect, a connector is provided. The connector includes a flange defining an opening. The connector also includes an insert having a plurality of plates. Each of the plates extends through the opening of the flange. The connector further includes an actuator coupling the insert to the flange. The plurality of plates are movable relative to the flange by operating the actuator.

In another aspect, a method of assembling a connector is provided. The method includes positioning an insert within an opening of a flange. The method also includes coupling the insert to the flange via an actuator. The insert has a plurality of plates that extend through the opening of the flange such that the plates are movable relative to the flange by operating the actuator.

In another aspect, a column for a moment-resisting frame is provided. The column includes a first hollow structural section (HSS) column segment and a second HSS column segment. The column also includes a connector coupling the first HSS column segment to the second HSS column segment. The connector includes a flange coupled between the HSS column segments and defining an opening. The connector also includes an insert having a plurality of plates that extend through the opening of the flange and into the HSS column segments such that the plates are spaced apart from one another. The connector further includes an actuator coupling the insert to the flange such that the plates are movably coupled to the actuator. The connector also includes a plurality of fasteners coupling the plates to the HSS column segments to prevent movement of the plates relative to the flange via the actuator.

### BRIEF DESCRIPTION OF THE DRAWINGS

FIG. 1 is a schematic illustration of a site at which an exemplary building frame is being erected;

FIG. 2 is an exploded view of an exemplary column that may be used in the frame shown in FIG. 1;

FIG. 3 is a perspective view of the column shown in FIG. 2 during a first stage of assembly; and

FIG. 4 is a perspective view of the column shown in FIG. 2 during a second stage of assembly.

### DETAILED DESCRIPTION

The following detailed description illustrates connectors and methods of assembling the same by way of example and not by way of limitation. The description should enable one of ordinary skill in the art to make and use the connectors, and the description describes several embodiments of connectors, including what is presently believed to be the best modes of making and using the connectors. An exemplary connector is described herein as being used to couple together support members in a building frame. However, it is contemplated that the connector has general application to a broad range of systems in a variety of fields other than frames of buildings.

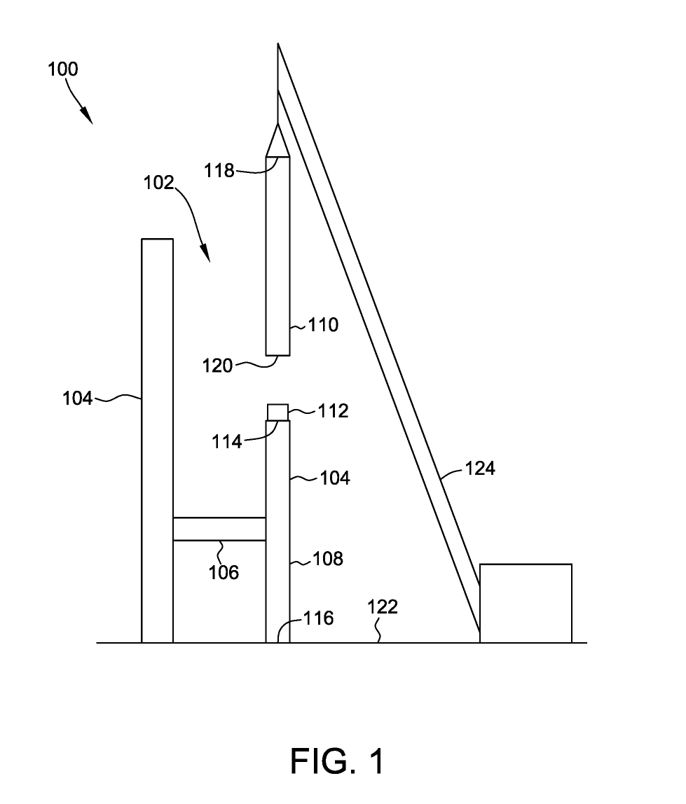

FIG. 1 is a schematic illustration of a site 100 at which an exemplary building frame 102 is being erected. In the exemplary embodiment, building frame 102 is a moment-resisting frame (e.g., a special moment frame or an intermediate moment frame) that includes a plurality of columns 104 and a plurality of beams 106. In some embodiments, columns 104 and beams 106 are fabricated from structural steel. In other embodiments, columns 104 and beams 106 may be fabricated from any other suitable material that facilitates enabling frame 102 to function as described herein.

In the exemplary embodiment, at least one column 104 of frame 102 includes a first column segment 108 and a second column segment 110 that are coupled together via a connector 112. More specifically, first column segment 108 has a first end 114 and a second end 116, and second column segment 110 similarly has a first end 118 and a second end 120. Column 104 is assembled onsite by coupling its associated first column segment 108 to its associated second column segment 110 at first end 114 and second end 120, respectively, using connector 112. Although first column segment 108 is illustrated as being coupled to a foundation 122 in the exemplary embodiment, first column segment 108 may not be coupled to foundation 122 in other embodiments (i.e., first column segment 108 may have any suitable position within frame 102, including a position that is elevated above foundation 122). Moreover, although second column segment 110 is illustrated as being lifted onto first column segment 108 using a crane 124 in the exemplary embodiment, second column segment 110 may be lifted onto first column segment 108 using any suitable method.

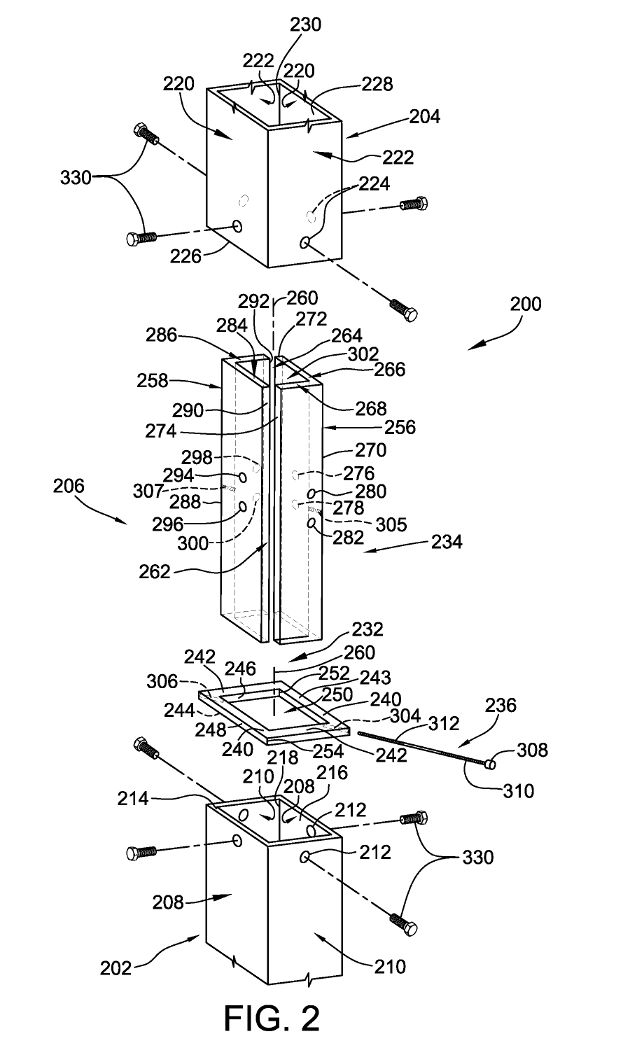

FIG. 2 is an exploded view of an exemplary column 200 that may be used in frame 102. Column 200 includes a first column segment 202, a second column segment 204, and a connector 206 for use in coupling first column segment 202 to second column segment 204. In the exemplary embodiment, each first column segment 202 and second column segment 204 is a hollow structural section (HSS). Alternatively, in some embodiments, first column segment 202 and/or second column segment 204 may be any suitable tubular column segment (e.g., at least one of first column segment 202 and second column segment 204 may not be a hollow structural section (HSS)). Moreover, in other embodiments, segments 202 and 204 may not be column segments, but may instead be another suitable type of tubular support member that is coupleable using connector 206, as described herein.

In the exemplary embodiment, first column segment 202 is defined by a pair of first side walls 208 and a pair of first end walls 210, each of which includes at least one first bolt hole 212 defined therein. First side walls 208 and first end walls 210 collectively define a first end surface 214 and a first inner surface 216 of first column segment 202. First inner surface 216 has a substantially rectangular cross-section at first end surface 214 (i.e., first inner surface 216 has four first inner corners 218 at first end surface 214, each first inner corner 218 being defined at the junction of a first side wall 208 and a first end wall 210). Likewise, in the exemplary embodiment, second column segment 204 has a pair of second side walls 220 and a pair of second end walls 222, each of which includes at least one second bolt hole 224 defined therein. Second side walls 220 and second end walls 222 collectively define a second end surface 226 and a second inner surface 228 of second column segment 204. Second inner surface 228 has a substantially rectangular cross-section at second end surface 226 (i.e., second inner surface 228 has four second inner corners 230 at second end surface 226, each second inner corner 230 being defined at the junction of a second side wall 220 and a second end wall 222). Notably, the substantially rectangular cross-section of first inner surface 216 at first end surface 214 is substantially the same size as the substantially rectangular cross-section of second inner surface 228 at second end surface 226. Although inner surfaces 216 and 228 of column segments 202 and 204, respectively, have cross-sections that are substantially rectangular and substantially the same size in the exemplary embodiment, inner surfaces 216 and 228 may have any suitable cross-sections in other embodiments. For example, at least one inner surface 216 and/or 228 may have a substantially square cross-section or a substantially circular cross-section, and/or inner surfaces 216 and 228 may not have cross-sections that are substantially the same size.

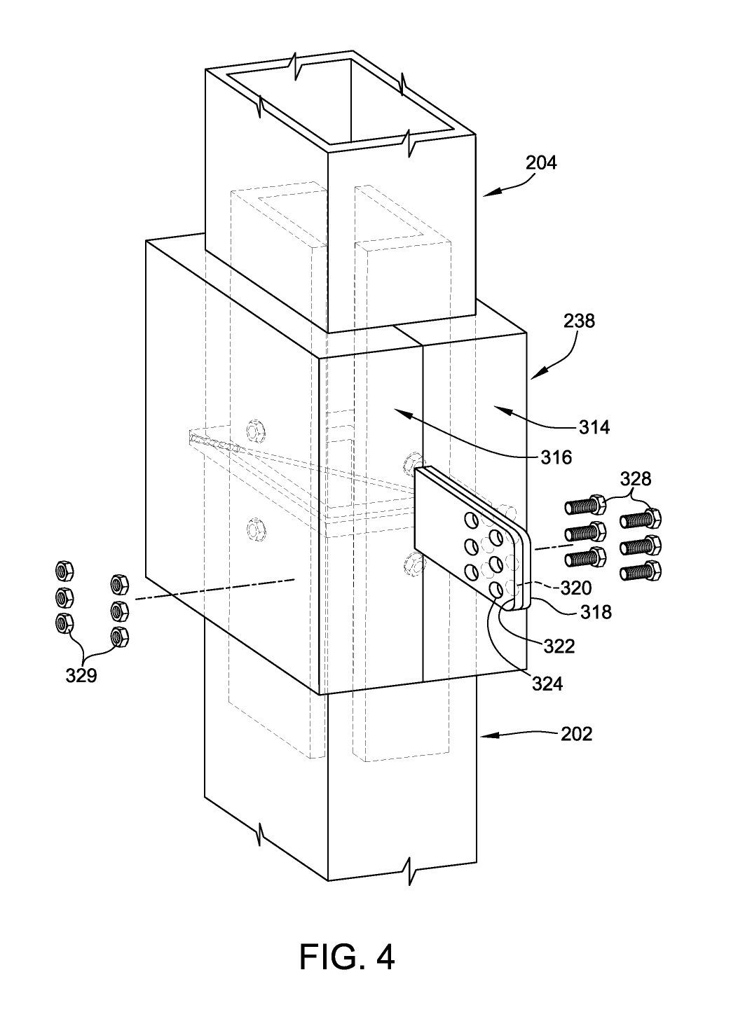

In the exemplary embodiment, connector 206 is a moment-resisting connector that includes a base (e.g., a flange 232), an insert 234, an actuator 236, and a housing 238 (shown in FIG. 4). Flange 232 has a pair of side segments 240 and a pair of end segments 242 that collectively define a top surface 243, a bottom surface 244, an inner surface 246, and an outer surface 248. Inner surface 246 forms a substantially rectangular central opening 250 (i.e., inner surface 246 has four inner corners 252, each inner corner 252 being defined at the junction of a side segment 240 and an end segment 242). Notably, opening 250 is substantially the same size as the substantially rectangular cross-section of first inner surface 216 of first column segment 202 and the substantially rectangular cross-section of second inner surface 228 of second column segment 204. Moreover, top surface 243 and bottom surface 244 extend outwardly from inner surface 246 to outer surface 248 such that outer surface 248 forms a substantially rectangular periphery of flange 232 (i.e., outer surface 248 has four outer corners 254, each outer corner 254 being defined at the junction of a side segment 240 and an end segment 242). In other embodiments, flange 232 and opening 250 may have any suitable shapes that facilitate enabling connector 206 to function as described herein (e.g., flange 232 and/or opening 250 may be substantially square or substantially circular in other embodiments). Alternatively, the base of connector 206 may not be in the form of flange 232, but may instead have any suitable shape that facilitates enabling connector 206 to function as described herein.

In the exemplary embodiment, insert 234 has a first plate 256 and a second plate 258 that, when positioned within opening 250 of flange 232, extend through opening 250 along a longitudinal axis 260 that is oriented substantially perpendicular to flange 232. As such, first plate 256 and second plate 258 define a pair of axial seams, namely a first seam 262 and a second seam 264. In other embodiments, insert 234 may have any suitable number of plates defining any suitable number of seams that facilitates enabling connector 206 to function as described herein (e.g., insert 234 may have four plates and four associated seams in other embodiments).

In the exemplary embodiment, first plate 256 includes a first side member 266 and a first end member 268 that are oriented substantially perpendicular to one another and adjoin one another at a first outer corner 270 such that first plate 256 has a substantially L-shaped cross-section. Notably, first side member 266 extends from first outer corner 270 to a first side edge 272, and first end member 268 extends from first outer corner 270 to a first end edge 274 such that first outer corner 270, first side edge 272, and first end edge 274 extend substantially parallel to axis 260. Moreover, first side member 266 has a plurality of first side bolt holes (e.g., an upper first side bolt hole 276 and a lower first side bolt hole 278), and first end member 268 has a plurality of first end bolt holes (e.g., an upper first end bolt hole 280 and a lower first end bolt hole 282). Likewise, second plate 258 includes a second side member 284 and a second end member 286 that are oriented substantially perpendicular to one another and adjoin one another at a second outer corner 288 such that second plate 258 has a substantially L-shaped cross-section. Notably, second side member 284 extends from second outer corner 288 to a second side edge 290, and second end member 286 extends from second outer corner 288 to a second end edge 292 such that second outer corner 288, second side edge 290, and second end edge 292 extend substantially parallel to axis 260. Moreover, second side member 284 has a plurality of second side bolt holes (e.g., an upper second side bolt hole 294 and a lower second side bolt hole 296), and second end member 286 has a plurality of second end bolt holes (e.g., an upper second end bolt hole 298 and a lower second end bolt hole 300). In other embodiments, first plate 256 and second plate 258 may have any suitable cross-sectional shapes that facilitate enabling connector 206 to function as described herein. For example, first plate 256 and second plate 258 may have an arcuate cross-section such that first plate 256 does not have first outer corner 270 and such that second plate 258 does not have second outer corner 288.

In the exemplary embodiment, first plate 256 and second plate 258 are substantially the same size and shape (e.g., first side member 266 is substantially the same size and shape as second side member 284, and first end member 268 is substantially the same size and shape as second end member 286). Moreover, first plate 256 and second plate 258 are oriented relative to one another such that first plate 256 and second plate 258 define a passage 302 along axis 260. More specifically, first plate 256 and second plate 258 are oriented such that first side member 266 opposes second side member 284, such that first end member 268 opposes second end member 286, and such that first outer corner 270 points away from second outer corner 288. Thus, first plate 256 and second plate 258 are spaced apart at seams 262 and 264 such that passage 302 has a substantially rectangular shape when viewed along axis 260. In other embodiments, plates 256 and 258 may have any suitable orientation relative to one another, and passage 302 may have any suitable shape that facilitates enabling connector 206 to function as described herein.

In the exemplary embodiment, plates 256 and 258 are positionable within opening 250 of flange 232 such that upper bolt holes 276, 280, 294, and 298 are above flange 232, and such that lower bolt holes 278, 282, 296, and 300 are below flange 232. Moreover, plates 256 and 258 are adjustably coupled to flange 232 by actuator 236 such that plates 256 and 258 are movable toward and away from axis 260 (and, therefore, one another) within opening 250 by operating actuator 236. Actuator 236 is a pin-type actuator (e.g., a threaded bolt or set screw) in the exemplary embodiment, and actuator 236 is extendable through an unthreaded bore 304 of flange 232, through a threaded bore 305 of first plate 256 at outer corner 270, across passage 302, through a threaded bore 307 of second plate 258 at outer corner 288, and into an unthreaded pivot slot 306 of flange 232 such that a grip 308 of actuator 236 (e.g., a bolt head) is accessible on the exterior of (or is external to) flange 232 at bore 304. Additionally, actuator 236 has a set of first threads 310 that engage first plate 256 at threaded bore 305 and are oriented in a first direction (i.e., right-handed threads), and actuator 236 also has a set of second threads 312 that engage second plate 258 at threaded bore 307 and are oriented in a second direction opposite the first direction (i.e., left-handed threads). Notably, actuator 236 is not threaded inside bore 304 or pivot slot 306, such that when grip 308 is turned clockwise, plates 256 and 258 move away from one another along actuator 236 such that seams 262 and 264 become wider and passage 302 becomes larger. Conversely, when grip 308 is turned counterclockwise, plates 256 and 258 move toward one another along actuator 236 such that seams 262 and 264 become narrower and passage 302 becomes smaller. In other embodiments, connector 206 may have any suitable type of actuator 236 that facilitates adjusting the position of plates 256 and 258 within opening 250 in the manner described herein.

In the exemplary embodiment, housing 238 (shown in FIG. 4) includes a first housing portion 314 and a second housing portion 316 that are sized to substantially enclose flange 232, actuator 236, and at least part of each plate 256 and 258 after plates 256 and 258 have been coupled to column segments 202 and 204, as set forth in more detail below. First housing portion 314 has a first tab 318 defining a plurality of first fastener apertures 320, and second housing portion 316 has a second tab 322 defining a plurality of second fastener apertures 324. First tab 318 and second tab 322 are oriented to seat against one another when first housing portion 314 is coupled to second housing portion 316. Moreover, first fastener apertures 320 are sized and spaced to align with second fastener apertures 324 when first tab 318 is seated against second tab 322, such that a plurality of fasteners 328 (e.g., bolts) can be inserted through aligned pairs of first and second fastener apertures 320 and 324 to fasten first housing portion 314 to second housing portion 316 via a plurality of associated nuts 329. In other embodiments, housing 238 may have any suitable number of portions that are coupled together in any suitable manner that facilitates enabling connector 206 to function as described herein.

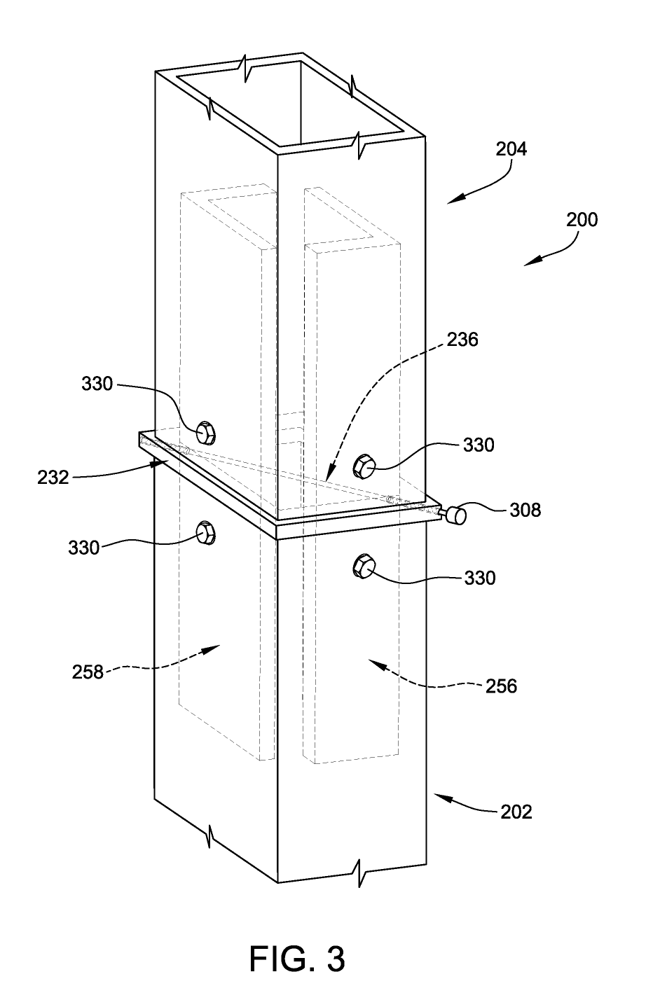

FIG. 3 is a perspective view of column 200 during a first stage of assembly, and FIG. 4 is a perspective view of column 200 during a second stage of assembly. To assemble column 200 onsite when erecting frame 102, first column segment 202 is coupled to a suitable structure (e.g., foundation 122 or another support member of frame 102). Connector 206 is then seated on first column segment 202 by seating bottom surface 244 of flange 232 on first end surface 214 of first column segment 202, such that first plate 256 and second plate 258 of insert 234 are inserted into first column segment 202. More specifically, first plate 256 is inserted into first column segment 202 such that first side member 266 of first plate 256 is oriented substantially parallel with a first side wall 208 of first column segment 202 in spaced relation thereto, and such that first end member 268 of first plate 256 is oriented substantially parallel with a first end wall 210 of first column segment 202 in spaced relation thereto. Similarly, second plate 258 is inserted into first column segment 202 such that second side member 284 of second plate 258 is oriented substantially parallel with the other first side wall 208 of first column segment 202 in spaced relation thereto, and such that second end member 286 of second plate 258 is oriented substantially parallel with the other first end wall 210 of first column segment 202 in spaced relation thereto. Thus, lower first side bolt hole 278 and lower first end bolt hole 282 are each aligned with the first bolt hole 212 of its associated first side wall 208 and the first bolt hole 212 of its associated first end wall 210, respectively. Similarly, lower second side bolt hole 296 and lower second end bolt hole 300 are each aligned with the first bolt hole 212 of its associated first side wall 208 and the first bolt hole 212 of its associated first end wall 210, respectively.

After connector 206 is seated on first column segment 202, second column segment 204 is then lowered onto connector 206 using crane 124 such that first plate 256 and second plate 258 are inserted into second column segment 204 and such that second end surface 226 of second column segment 204 is seated on top surface 243 of flange 232. More specifically, first plate 256 is inserted into second column segment 204 such that first side member 266 of first plate 256 is oriented substantially parallel with a second side wall 220 of second column segment 204 in spaced relation thereto, and such that first end member 268 of first plate 256 is oriented substantially parallel with a second end wall 222 of second column segment 204 in spaced relation thereto. Similarly, second plate 258 is inserted into second column segment 204 such that second side member 284 of second plate 258 is oriented substantially parallel with the other second side wall 220 of second column segment 204 in spaced relation thereto, and such that second end member 286 of second plate 258 is oriented substantially parallel with the other second end wall 222 of second column segment 204 in spaced relation thereto. Thus, upper first side bolt hole 276 and upper first end bolt hole 280 are each aligned with the second bolt hole 224 of its associated second side wall 220 and the second bolt hole 224 of its associated second end wall 222, respectively. Similarly, upper second side bolt hole 294 and upper second end bolt hole 298 are each aligned with the second bolt hole 224 of its associated second side wall 220 and the second bolt hole 224 of its associated second end wall 222, respectively.

With second column segment 204 seated on connector 206, grip 308 of actuator 236 is then turned clockwise (e.g., via a wrench or suitable power tool) such that first threads 310 drive first plate 256 away from second plate 258 to seat first side member 266 and first end member 268 of first plate 256 against first column segment 202 and second column segment 204. Conversely, second threads 312 drive second plate 258 away from first plate 256 to seat second side member 284 and second end member 286 of second plate 258 against first column segment 202 and second column segment 204. A plurality of fasteners (e.g., bolts 330 such as, for example, blind bolts) are then inserted into first bolt holes 212 to engage first plate 256 via bolt holes 278 and 282, and to engage second plate 258 via bolt holes 296 and 300. A plurality of bolts 330 are then inserted into second bolt holes 224 to engage first plate 256 via bolt holes 276 and 280, and to engage second plate 258 via bolt holes 294 and 298. Upon tightening bolts 330, first plate 256 and second plate 258 are prevented from moving along actuator 236 (even though plates 256 and 258 are movably coupled to actuator 236), and axial movement of first column segment 202 relative to second column segment 204 is also prevented. After bolts 330 are tightened, first housing portion 314 and second housing portion 316 are then seated on flange 232 such that first tab 318 and second tab 322 are seated against one another. Fasteners 328 are then inserted into the aligned first fastener apertures 320 and second fastener apertures 324 to couple with nuts 329 and fasten first housing portion 314 to second housing portion 316 such that housing 238 completely encloses flange 232, actuator 236, and bolts 330.

The methods and systems described herein facilitate erecting a moment-resisting frame at a building site. More specifically, the methods and systems facilitate coupling HSS column segments together onsite using a connector that is not welded to the HSS column segments. The methods and systems thereby facilitate eliminating the time that would otherwise be required to weld column segments to one another and/or to the connector. As such, the methods and systems facilitate transporting longer columns to a building site in segments and assembling the columns at the building site by coupling the associated column segments together using a moment-resisting connector that is strictly mechanical in nature. As such, the methods and systems facilitate reducing the time and cost associated with erecting a multistory, moment-resisting frame at a building site.

Exemplary embodiments of connectors and methods of assembling the same are described above in detail. The methods and systems described herein are not limited to the specific embodiments described herein, but rather, components of the methods and systems may be utilized independently and separately from other components described herein. For example, the methods and systems described herein may have other applications not limited to practice with frames of buildings, as described herein. Rather, the methods and systems described herein can be implemented and utilized in connection with various other industries.

While the invention has been described in terms of various specific embodiments, those skilled in the art will recognize that the invention can be practiced with modification within the spirit and scope of the claims.

What is claimed is:

1. A connector comprising:
a flange defining an opening;
an insert comprising a plurality of plates, wherein each of said plates extends through the opening of said flange; and
an actuator coupling said insert to said flange, wherein said plurality of plates are movable relative to said flange by operating said actuator.

2. A connector in accordance with claim 1, wherein said connector is a moment-resisting connector.

3. A connector in accordance with claim 1, wherein said plurality of plates comprises a pair of substantially L-shaped plates.

4. A connector in accordance with claim 1, wherein said actuator comprises a threaded bolt.

5. A connector in accordance with claim 4, wherein said plurality of plates are movable along said threaded bolt when said threaded bolt is turned relative to said plates.

6. A connector in accordance with claim 1, further comprising a housing sized to contain said flange and said actuator.

7. A method of assembling a connector, said method comprising:
positioning an insert within an opening of a flange; and
coupling the insert to the flange via an actuator, wherein the insert has a plurality of plates that extend through the opening of the flange such that the plates are movable relative to the flange by operating the actuator.

8. A method in accordance with claim 7, further comprising fabricating said connector as a moment-resisting connector.

9. A method in accordance with claim 7, further comprising fabricating said plurality of plates as a pair of substantially L-shaped plates.

10. A method in accordance with claim 7, wherein coupling the insert to the flange via an actuator comprises coupling the insert to the flange via a threaded bolt.

11. A method in accordance with claim 10, wherein coupling the insert to the flange via a threaded bolt comprises coupling the insert to the flange such that the plates are movable along the threaded bolt when the threaded bolt is turned relative to the plates.

12. A method in accordance with claim 7, further comprising coupling a housing to the flange such that the flange and the actuator are contained within the housing.

13. A column for a moment-resisting frame, said column comprising:
a first hollow structural section (HSS) column segment;
a second HSS column segment; and
a connector coupling said first HSS column segment to said second HSS column segment, wherein said connector comprises:
a flange coupled between said HSS column segments and defining an opening;
an insert comprising a plurality of plates that extend through the opening of said flange and into said HSS column segments such that said plates are spaced apart from one another;
an actuator coupling said insert to said flange such that said plates are movably coupled to said actuator; and
a plurality of fasteners coupling said plates to said HSS column segments to prevent movement of said plates relative to said flange via said actuator.

14. A column in accordance with claim 13, wherein said connector is a moment-resisting connector.

15. A column in accordance with claim 13, wherein said plurality of plates comprises a pair of substantially L-shaped plates.

16. A column in accordance with claim 13, wherein said actuator comprises a threaded bolt.

17. A column in accordance with claim 16, wherein said threaded bolt comprises a grip that is external to said flange.

18. A column in accordance with claim 13, wherein said connector further comprises a housing coupled to said flange to contain said flange and said actuator therein.

19. A column in accordance with claim 13, wherein each of said first column segment and said second column segment is fabricated from structural steel.

20. A column in accordance with claim 19, wherein said connector is coupled to said first column segment and said second column segment without welding said connector to said first column segment or said second column segment.
